(19) United States
(12) Patent Application Publication
(10) Pub. No.: US 2023/0092111 A1
(43) Pub. Date: Mar. 23, 2023

(54) METHOD AND APPARATUS FOR EXTRACTING RULES-BASED EVENT FROM SPORTS MATCH VIDEO

(71) Applicant: POSTECH Research and Business Development Foundation, Pohang-si (KR)

(72) Inventors: Minseok SONG, Pohang-si (KR); Min Chul JEONG, Ansan-si (KR)

(73) Assignee: POSTECH Research and Business Development Foundation, Pohang-si (KR)

(21) Appl. No.: 17/948,188

(22) Filed: Sep. 19, 2022

(30) Foreign Application Priority Data
Sep. 23, 2021 (KR) 10-2021-0125838

(51) Int. Cl. G06V 20/40

(52) U.S. Cl. CPC G06V 20/44; G06V 20/46; G06V 20/42

(57) ABSTRACT

Disclosed is a method and apparatus for extracting rules-based events from a soccer match video. The method of extracting a rules-based event from a soccer match video includes setting rules for each category of events to be extracted from a sports match video; extracting ball possession and ball coordinates based on tracking coordinate data of at least one player and tracking coordinate data of a ball in the sports match video, identifying that an event of a specific category is started at a specific point in time of the sports match video when a condition for before a start of an event and a condition for after a start of an event in the rule are satisfied, and identifying that the event is ended at another specific point in time of the sports match video when a condition for an end of an event in the rule is satisfied.

### CROSS-REFERENCE TO RELATED APPLICATIONS

This application claims priority to Korean Patent Application No. 10-2021-0125838, filed on Sep. 23, 2021 in the Korean Intellectual Property Office (KIPO), the entire contents of which are hereby incorporated by reference.

### BACKGROUND

### 1. Technical Field

The present invention relates to a method and apparatus for extracting a rules-based event from a sports match video.

### 2. Related Art

As big data and artificial intelligence (AI) technologies develop in the 4^{th} industrial revolution era, various studies using the technologies in the field of sports have been conducted. In basketball, the American National Basketball Association (NBA) league cooperates with Second Spectrum, a sports match video analysis company, to provide advanced indicators, such as a real-time shot success probability, a rebound probability, and the like. In soccer, the German national team, which won the 2014 World Cup in Brazil, has cooperated with System Analysis Program Development (SAP), an IT solution company, to provide big data-based sports match video analysis.

In addition, there is a requirement for development of a technology for supporting a performance analyzer by automating sports match event extraction, which was previously performed manually by the performance analyzer, based on location data and rules set by a user.

Representatively, not only in domestic soccer match video analysis companies, such as beproll, and national soccer teams, but also in overseas sports match video analysis companies, such as Opta and Wyscout, soccer event extraction is manually performed by performance analysts. The soccer event extraction is performed by a method of a team of three people extracting an event, by the three people watching a game video, one person extracting an event of a home team, another person extracting an event of an away team, and the remaining person verifying the events of the two teams.

In order to automate the soccer event extraction by the performance analyzer, studies have been conducted to extract an event from motions of players and referees in a sports match video or extract an event by calculating the speed of a ball from coordinate data.

The conventional technologies, to automate manually performed soccer event extraction, are dominated by a technology for extracting action events, such as passes and shoots. However, in the conventional technologies, action events occur more than 2,000 times on average in one game, and passes account for more than about 50% of the action events, and in order to analyze the opponent's strategy and tactics, more than 2,000 actions per game need to be analyzed, which is highly time consuming.

Therefore, in order to automate soccer event extraction, rather than extracting an action event, a technology for extracting tactical events, such as flank attacks and counterattacks, which are actually useful for tactical analysis, is required.

### SUMMARY

Accordingly, example embodiments of the present invention are provided to substantially obviate one or more problems due to limitations and disadvantages of the related art.

Example embodiments of the present invention provide a method and apparatus for extracting a ruled-based event from a soccer match video by analyzing an opponent's strategy and tactics based on a sports match video taken in a sports stadium and tracking coordinate data of players and a ball extracted from the video.

In some example embodiments, a method of extracting a rules-based event from soccer match video may include: setting rules for each category of events to be extracted from a sports match video; extracting ball possession and ball coordinates based on tracking coordinate data of at least one player and tracking coordinate data of a ball in the sports match video; identifying that an event of a specific category is started at a specific point in time of the sports match video when a condition for before a start of an event and a condition for after a start of an event in the rule are satisfied; and identifying that the event is ended at another specific point in time of the sports match video when a condition for an end of an event in the rule is satisfied.

The categories may include an attack category, a defense category, an attack switch category, a defense switch category, and a set piece category, and each of the categories includes a plurality of preset sub-categories.

The rules may include a rule for before the start of an event, a rule for after the start of an event, and a rule for the end of an event, and each of the rule for before the start of the event, the rule for after the start of the event, and the rule for the end of the event includes a condition for ball possession, a condition for ball coordinates, and a time condition.

The tracking coordinate data and the ball coordinates may be extracted based on a coordinate system in which coordinates of one corner of a soccer field in the sports match video are set to (0.0), and coordinates of another corner located diagonally opposite to the one corner are set to (1.1).

Ball-out and ball-in, which are default rules among the rules, may have parameters in which the parameters for the ball-out are defined as (0.0>Ball_x), (1.0<Ball_x), (0.0>Ball_y) or (1.0<Ball_y) and the parameters for the ball-in are defined as (0.0<Ball_x<1.0) and (0.0<Ball_y<1.0), wherein the Ball_x and the Ball_y represent an x coordinate and a y-coordinate of the ball, respectively.

The method may further comprise, tagging the ball possession with “Home” when a player closest to the ball belongs to a home team, and tagging the ball possession with “Away” when a player closest to the ball belongs to an away team; and while checking a player who is the closest to the ball at certain time intervals, when a team not having had the ball possession remains the closest to the ball for a predetermined time limit, switching the ball possession to the opposing team.

The method may further comprise setting a predetermined time limit to prevent a situation in which, when one player of the team having the ball possession passes the ball to another player of the same team, the movement of the ball causes the ball possession to be tagged with the opposing team.

The sub-categories of the attack category among the categories may include a flank attack, a midfielder (MF) attack, a center back (CB) build-up, and a goalkeeper (GK) build-up. The sub-categories of the defense category among the categories may include a P1 defense, a P2 defense, and a P3 defense, the sub-categories of the defense switch category among the categories include a P2 defense switch and a P3 defense switch, the sub-categories of the attack switch category among the categories include a P1 attack switch and a P attack switch, and the sub-categories of the set piece category among the categories include a corner kick and a throw-in.

The event may include a flank attack event, an MF attack event, a CB build-up event, a GK build-up event, a P1 defense event, a P2 defense event, a P3 defense event, a P2 defense switch event, a P3 defense switch event, a P1 attack switch event, a P2 attack switch event, a corner kick event, and a throw-in event.

The start and the end of the event may be determined according to a condition that is set in advance for each event corresponding to a specific item of the sub-category.

In other example embodiments, an apparatus for extracting a rules-based event from a soccer match video may include: a processor; and a memory in which at least one command executed by the processor is stored, wherein the at least one command is configured to allow the processor to perform operations of: setting rules for each category of events to be extracted from a sports match video; extracting a ball possession and ball coordinates based on tracking coordinate data of at least one player and tracking coordinate data of a ball in the sports match video; when a condition for before a start of an event and a condition for after a start of an event in the rule are satisfied, identifying that an event of a specific category is started at a specific point in time of the sports match video; and when a condition for an end of an event in the rule is satisfied, identifying that the event is ended at another specific point in time of the sports match video.

In still other example embodiments, an apparatus for extracting a rules-based event from a soccer match video may include: a ball possession extraction unit configured to a ball possession from tracking coordinate data of a player and a ball extracted from a sports match video, and a list of the extracted ball possession in a ball possession list storage unit; a category-specific rule setting unit configured to set a rule for before a start of an event, a rule for after a start of an event, and a rule for an end of an event as category-specific rules on the basis of a ball possession condition, a ball coordinate condition, and a time condition that are extracted according to a user input parameter stored in a user input parameter storage unit, and store the set category-specific rules in a category-specific rule storage unit; a rule-based event extraction unit configured to, when an event of a specific category starts at a specific point in time of the sports match video in response to the rule for before the start of the event and the rule for after the start of the event being satisfied and the event ends at another specific point in time of the sports match video in response to the rule for the end of the event being satisfied, store a rule-based event that is completed with an event start and an event end as a candidate event for each category in a category-specific candidate event storage unit; a category-specific event adjusting unit configured to, while checking the extracted candidate event for each category, add or remove an event to generate an event list for each category, and store the generated event list for each category in a category-specific event list storage unit; and a category-specific event reproduction unit configured to, after event extraction is complete, reproduce an event with the sports match video stored in a sports match video storage unit and a 2D or Voronoi animation stored in an animation storage unit.

The apparatus may further comprise a tracking coordinate data extraction unit configured to extract tracking coordinate data including coordinates of a player, coordinates of a ball, and time data on the basis of coordinate data of the player and the ball from the sports match video in a coordinate data storage unit.

The tracking coordinate data, the coordinates of the player, and the coordinates of the ball may be extracted based on a coordinate system in which coordinates of one corner of a soccer field in the sports match video are set to (0.0), and coordinates of another corner located diagonally opposite to the one corner are set to (1.1).

Ball-out and ball-in, which are default rules, may have parameters in which the parameters for the ball-out are defined as (0.0>Ball_x), (1.0<Ball_x), (0.0>Ball_y) or (1.0 <Ball_y) and the parameters for the ball-in are defined as (0.0<Ball_x<1.0) and (0.0<Ball_y<1.0), wherein the Ball_x and the Ball_y represent an x coordinate and a y coordinate of the ball, respectively.

The category-specific event adjusting unit may be configured to tag the ball possession with “Home” when a player closest to the ball belongs to a home team, and tag the ball possession with “Away” when a player closest to the ball belongs to an away team; and while checking a player who is the closest to the ball at certain time intervals, when a team not having had the ball possession remains the closest to the ball for a predetermined time limit, switch the ball possession to the opposing team.

The category-specific event adjusting unit may be configured to set a predetermined time limit to prevent a situation in which, when one player of the team having the ball possession passes the ball to another player of the same team, movement of the ball causes the ball possession to be tagged with the opposing team.

The categories may include an attack category, a defense category, an attack switch category, a defense switch category, and a set piece category. The sub-categories of the attack category may include a flank attack, a midfielder (MF) attack, a center back (CB) build-up, and a goalkeeper (GK) build-up, the sub-categories of the defense category include a P1 defense, a P2 defense, and a P3 defense, the sub-categories of the defense switch category include a P2 defense switch and a P3 defense switch, the sub-categories of the attack switch category include a P1 attack switch and a P attack switch, and the sub-categories of the set piece category include a corner kick and a throw-in.

The event may include a flank attack event, an MF attack event, a CB build-up event, a GK build-up event, a P1 defense event, a P2 defense event, a P3 defense event, a P2 defense switch event, a P3 defense switch event, a P1 attack switch event, a P2 attack switch event, a corner kick event, and a throw-in event.

The start and the end of the event may be determined according to a condition that is set in advance for each event corresponding to a specific item of the sub-category.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a system for extracting a rules-based event from a soccer match video according to the present invention;

FIG. 2 is a flowchart showing an event extraction scenario of an apparatus for extracting a rules-based event from a sports match video according to an embodiment of the present invention;

FIG. 3 is an exemplary diagram illustrating extraction of tracking coordinate data of an apparatus for extracting a rules-based event from a sports match video according to an embodiment of the present invention;

FIG. 4 is a conceptual diagram for describing tracking coordinate data of an apparatus for extracting a soccer event based on an event according to an embodiment of the present invention;

FIG. 5 is a schematic diagram for describing a criterion for extracting ball possession of an apparatus for extracting a rules-based event from a sports match video according to an embodiment of the present invention;

FIG. 6 is a schematic diagram for describing a process of setting a category-specific rule of an event by an apparatus for extracting a rules-based event from a sports match video according to an embodiment of the present invention;

FIGS. 7A to 7C are schematic diagrams for describing an example of a process of setting a category-specific rule for a flank attack of an apparatus for extracting a rules-based event from a sports match video according to an embodiment of the present invention;

FIGS. 8 to 11 illustrate default rule parameters and start rules and end rules for each category of an event extraction module of the apparatus for extracting a rules-based event from a sports match video according to an embodiment of the present invention;

FIG. 12 is a block diagram of an apparatus for extracting a rules-based event from a sports match video according to an embodiment of the present invention;

FIGS. 13A and 13B are schematic diagrams for describing an example of a rule-applied correct answer of an apparatus for extracting a rules-based event from a sports match video according to an embodiment of the present invention; and

FIGS. 14A and 14B are schematic diagrams for describing an example of a rule-applied incorrect answer of an apparatus for extracting a rules-based event from a sports match video according to an embodiment of the present invention.

### DETAILED DESCRIPTION OF THE EMBODIMENTS

Example embodiments of the present invention are disclosed herein. However, specific structural and functional details disclosed herein are merely representative for purposes of describing example embodiments of the present invention, and example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a” and “an” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by those of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

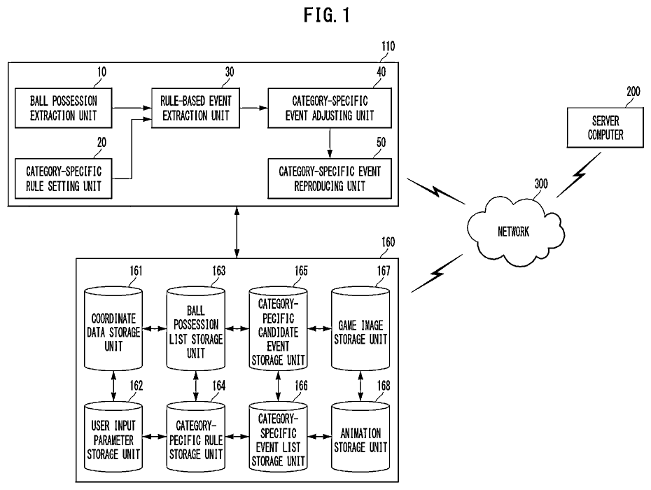

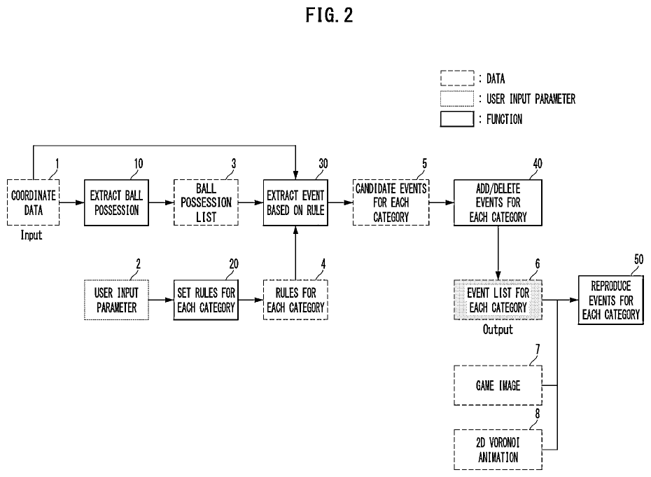

FIG. 1 is a block diagram illustrating a system for extracting a rules-based event from a sports match video according to the present invention. FIG. 2 is a flowchart showing an event extraction scenario of an apparatus for extracting a rules-based event from a sports match video according to an embodiment of the present invention.

Referring to FIG. 1, a block diagram for describing a configuration of an event extraction scenario of the apparatus for extracting a rules-based event from a sports match video according to the present invention is illustrated. The system for extracting an event based on a rule according to the present invention includes an apparatus 100 for extracting a rules-based event from a sports match video and a server computer 200.

The apparatus 100 for extracting a rules-based event from a sports match video may include a processor 110 and a storage device 160, and may further include a ball possession extraction unit 10, a category-specific rule setting unit 20, a rule-based event extraction unit 30, a category-specific event adjusting unit 40, and a category-specific event reproducing unit 50. Preferably, the apparatus 100 for extracting a rules-based event from a sports match video may further include a tracking coordinate data extraction unit 25.

Referring to FIG. 2 together with FIG. 1, the ball possession extraction unit 10 extracts ball possession from player and ball tracking coordinate data 1 extracted from a sports match video 7, and stores a list 3 of the extracted ball possession in a ball possession list storage unit 163.

The category-specific rule setting unit 20 sets a rule for before the start of an event, a rule for after the start of an event, and a rule for the end of an event as category-specific rules 4 based on a ball possession condition, a ball coordinate condition, and a time condition that are extracted according to a user input parameter 2 stored in a user input parameter storage unit 162, and stores the set category-specific rules 4 in a category-specific rule storage unit 164.

The rule-based event extraction unit 30 determines rule-based events that are completed with the event start and the event end as category-specific candidate events 5, and stores the category-specific candidate events 5 in a category-specific candidate event storage unit 165. An event may be set to start when both the rule for before the start of an event and the rule for after the start of an event are satisfied during a sports match, and set to end when a rule for the end of an event is satisfied.

The category-specific event adjusting unit 40, while checking the extracted category-specific candidate event, adds or removes an event to generate a category-specific event list 6, and stores the generated category-specific event list 6 in a category-specific event list storage unit 166.

The category-specific event reproducing unit 50, after completion of event extraction, reproduces the event with a sports match video 7 stored in the sports match video storage unit 167 and a 2D Voronoi animation 8 stored in an animation storage unit 168 while performing analysis of strategy and tactics.

The tracking coordinate data extraction unit 25 extracts the player and ball tracking coordinate data 1 from the prepared sports match video 7, and stores the extracted player and ball tracking coordinate data 1 in the coordinate data storage unit 161. The player and ball tracking coordinate data 1 extracted and stored in the coordinate data storage unit 161 includes coordinates of a player, coordinates of a ball, and time data. The tracking coordinate data extraction unit 25 may be included as a separate component in the apparatus 100 for extracting a rules-based event from a sports match video according to the present invention, or may be included in the ball possession extraction unit 10, and in some cases, the player and ball tracking coordinate data 1 including coordinates of a player, coordinates of a ball, and time data may be input from the server computer 200 via a network 300 in real time.

Referring again to FIGS. 1 and 2, an event extraction scenario in which the candidate event 5 is extracted based the player and ball tracking coordinate data 1 and rules of the apparatus 100 for extracting a rules-based event from a sports match video according to an embodiment of the present invention is illustrated.

The apparatus 100 for extracting a rules-based event from a sports match video according to the present invention extracts the category-specific candidate event 5 from the tracking coordinate data 1, the extracted ball possession list 3, and the category-specific rule 4 based on the user input parameter 2. In this case, the tracking coordinate data 1 may be extracted at a rate of 1 to 20 frames per second (fps).

Since there are cases in which no event is extracted or the extracted event does not actually correspond to a category, the apparatus 100 for extracting a rules-based event from a sports match video generates the category-specific event list 6 by adding or removing an event while checking the extracted category-specific candidate event 5.

When event extraction is completed, the event is reproduced with the sports match video 7, the 2D Voronoi animation 8, and the like to perform analysis of strategy and tactics.

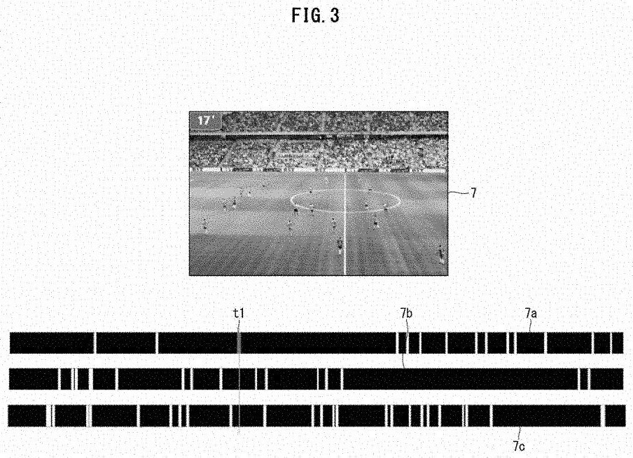

FIG. 3 is an exemplary diagram illustrating extraction of tracking coordinate data of the apparatus for extracting a rules-based event from a sports match video according to an embodiment of the present invention.

Referring to FIG. 3, the illustrated sports match video 7 is a scene of an image corresponding to a category of flank attack. From the sports match video 7, a timeline of moments when a flank attack occurs at a specific point in time t1 may be extracted (7a), a timeline of moments when a P1 defense occurs may be extracted (7b), and a timeline of moments in which a throw-in occurs may be extracted (7c).

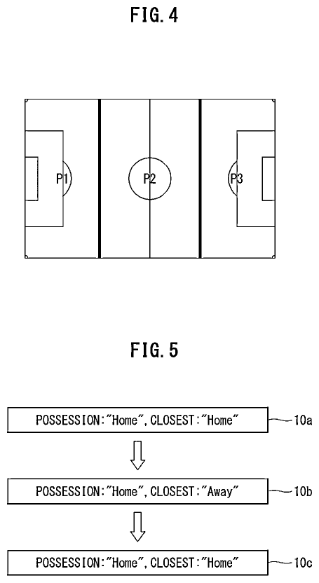

FIG. 4 is a conceptual diagram for describing tracking coordinate data of the apparatus for extracting a soccer event based on an event according to an embodiment of the present invention.

Referring to FIG. 4, a P1 defense is defined when a stadium is divided into three parts P1, P2, and P3 as shown in FIG. 3, and a region of a first team is referred to as P1, a midfield region is referred to as P2, and a region of a second team is referred to as P3.

In this case, in each of the P1, P2, and P3 areas, the players of the first team and the second team perform a combination of sequences on a series of tactics, such as an attack, a defense, an attack switch (a counterattack), a defense switch (a counterattack), a set piece, and the like, over possession of a ball.

TABLE 1

| | | Attack switch | Defense switch | Set piece |
|---|---|---|---|---|
| Attack | Defense | (counter attack) | (counter attack) | |
| Flank attack | P1 area | P1 area | P2 area | Corner kick |
| MF attack | P2 area | P2 area | P3 area | Throw-in |
| GK buildup | P3 area | — | — | — |
| CK buildup | — | — | — | — |

Referring to Table 1, the apparatus for extracting a rules-based event from a sports match video according to the embodiment of the present invention may broadly classify soccer tactics into an attack, a defense, an attack switch (a counterattack), a defense switch (a counterattack), and a set piece, and as sub-tactics, classify the attacks into a flank attack, an MF attack, a GK build-up, and a CK build-up, classify the defenses into a P1 area defense, a P2 area defense, and a P3 area defense, classify the attack switches (counterattacks) into a P1 area attack switch (a counterattack) and a P2 area attack switch (a counterattack), and classify the defense switches (counterattacks) into a P2 area defense switch (a counterattack) and a P3 area defense switch (a counterattack). The set pieces may be classified into a corner kick and a throw-in.

Referring to FIGS. 2 to 4, a criterion for extracting the tracking coordinate data 1 from the prepared sports match video 7 is determined from a case in which the player of the first team or the second team has had ball possession. The ball possession may be extracted from the player and ball tracking coordinate data 1 extracted from the sports match video 7.

When extracting ball possession from the player and ball tracking coordinate data 1 extracted from the sports match video 7, the apparatus for extracting a rules-based event from a sports match video according to the present invention starts the ball possession extraction by tagging the ball possession with Home when a player closest to the ball at the start of the sports match is the home team, and tagging the ball possession with Away when a player closest to the ball at the start of the sports match is the away team, and while checking the closest player to the ball in certain units smaller than or equal to seconds, switches the possession when a team having not had possession remains the closest to the ball for three seconds. Here, the limit of three seconds is to prevent a situation such as when a player of one team passes a ball to another player of the same team, and the movement of the ball causes the possession to be tagged with the opposing team.

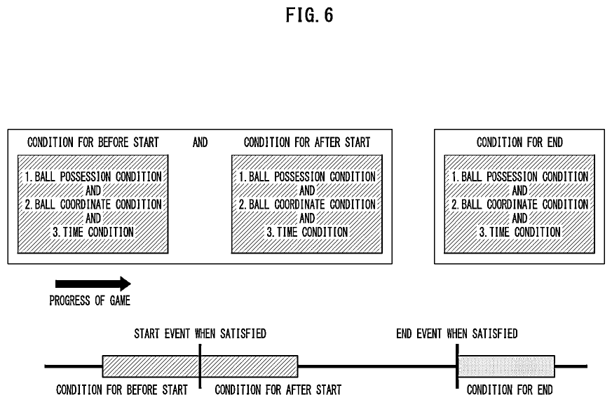

FIG. 5 is a schematic diagram for describing a criterion for extracting the ball possession of the apparatus 100 for extracting a rules-based event from a sports match video according to the embodiment of the present invention.

Referring to FIG. 5, the criterion for extracting the ball possession from the player and ball tracking coordinate data 1 extracted from the sports match video 7 by the apparatus 100 for extracting a rules-based event from a sports match video according to the embodiment of the present invention is illustrated. Here, the criterion for extracting the ball possession from the player and ball tracking coordinate data 1 extracted from the sports match video 7 are provided using two criteria of the possession and the closest based on distance data from each player to the ball and retention time data.

For example, one player of the first team is the closest to the ball and the one player of the first team is identified as having the possession of the ball. It is determined as possession (Home) and closest (Home) (10a). The one player in the first team has moved away from the ball, but continues to have the possession, and the possession has not yet passed to a player from the other team, so the possession is still held by the one player on the first team, but the player is not the closest to the ball. It is determined as possession (Home) and closest (Away) (10b). One of the players of the first team has received the possession of the ball and became the closest player, but since the possession of the ball is transferred between players of the same team, it is determined again as possession (Home) and closest (Home) (10c).

In this case, in order to prevent a situation when a player of one team passes a ball to another player of the same team and the movement of the ball causes the possession to be tagged with the opposing team, a predetermined time limit may be set, and in an embodiment of the present invention, the predetermined time limit is set to three seconds, but is not limited thereto, and the predetermined time limit may be set differently depending on the nature of the sports match. For example, in youth soccer, the predetermined time limit may be set to 3.5 seconds, and in soccer for professional players, the predetermined time limit may be set to 2.5 seconds.

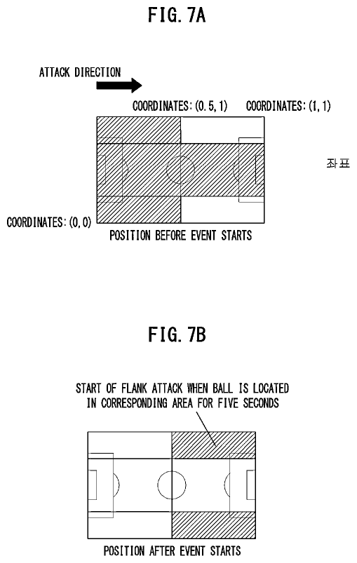

FIG. 6 is a schematic diagram for describing a process of setting a category-specific rule of an event by the apparatus for extracting a rules-based event from a sports match video according to an embodiment of the present invention.

In the embodiment, a process of setting a category-specific rule of an event to be extracted by the apparatus 100 for extracting a rules-based event from a sports match video will be described.

Referring to FIG. 6, after completing ball possession extraction (S100), a category-specific rule of an event to be extracted is set, and the rules of the apparatus 100 for extracting a rules-based event from a sports match video according to the embodiment of the present invention include a rule for before the start of an event 4a, a rule for after the start of an event 4b, and a rule for the end of an event 4c, and each rule includes a ball possession condition, a ball coordinate condition, and a time condition.

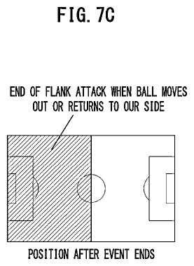

FIGS. 7A to 7C are schematic diagrams for describing an example of a process of setting a category-specific rule for a flank attack of the apparatus 100 for extracting a rules-based event from a sports match video according to an embodiment of the present invention.

Referring to FIGS. 7A to 7C, an example of setting a category-specific rule of a flank attack by the apparatus for extracting a rules-based event from a sports match video will be described.

First, among default rule parameters, ball-out is set to (0.0>Ball_x), (1.0<Ball_x), (0.0>Ball_y) or (1.0<Ball_y), and ball-in is set to (0.0<Ball_x<1.0) and (0.0<Ball_y<1.0). An x-y coordinate system may be arbitrarily set with the lower end of one side in the sports match video 7 as the origin (0,0), the diagonal corner as a point (1,1), the horizontal direction as an x axis, and the vertical direction as a y axis. The coordinates of a ball extracted from the sports match video 7 may be expressed as two-dimensional coordinates of (x, y). In this case, the possession of the ball may be secured when the coordinates (x, y) of the ball are inside the stadium, and the possession of the ball is reserved when the coordinates (x, y) of the ball are outside the stadium, which is based on the rules of a soccer match.

Next, the category-specific rule including the rule for before the start of an event, the rule for after the start of an event, and the rule for the end of an event may be set as shown in Table 2. Each of the rule for before the start of an event, the rule for after the start of an event, and the rule for the end of an event is defined by a ball possession condition, a ball coordinate condition, and a time condition.

TABLE 2

| | Sub- | Start rule | | End rule |
|---|---|---|---|---|
| Category | category | Before start of event | After start of event | After end of event |
| Attack | Flank attack | 1. ball possession | 1. ball possession | 1. ball possession |
| | | condition: home | condition: home | condition: Away |
| | | 2. ball coordinate | 2. ball coordinate | 2. ball coordinate |
| | | condition: Ball_x ≤ | condition: {0.5 ≤ | condition: Ball_x ≤ |
| | | 0.5 or (0.25 ≤ | Ball_x and | 0.5 or Ball-out and |
| | | Bal_y ≤ 0.75) | (Ball_y ≤ 0.25 or | 3. start condition: |
| | | 3. start condition: - | Ball_y ≥ 0.75) | duration of 3 sec |
| | | | 3. start condition: | |
| | | | duration of 5 sec | |

An event starts when both the rule for before the start of the event and the rule for after the start of the event are satisfied, and the event ends when the rule for the end of the event is satisfied.

For example, in the case of setting a category-specific rule of a flank attack as shown in FIGS. 7A to 7C, first, a case in which the possession condition of the ball is that it is with the first team may be set as Home, and a case in which the possession condition of the ball is that it is with the second team may be set as Away.

Specifically, the coordinate condition of the ball may be in a hatched area, which is the position before the start of an event as shown in FIG. 7A, and as the attack direction proceeds to the right, the coordinate condition of the ball may reach another hatched area, which is the position after the start of the event as shown in FIG. 7B, at the next point in time. In this case, when the ball is located in the area for five seconds, it is determined as the start of a flank attack tactic. That is, in order to determine a tactic as the start of a flank attack, the ball possession condition, the ball coordinate condition, and the time condition for each of the rule for before the start of the event and the rule for after the start of the event need to be satisfied.

Next, when the coordinate condition of the ball, which is the position after the end of the event as shown in FIG. 7C, corresponds to Away, and the time condition lasts for three seconds, it is determined that the event ends. That is, the end of the flank attack tactic is determined when the ball possession condition is Away, the ball is outside the area for three seconds or returns to the side of the first team, or the ball moves out of the stadium.

Here, among the rules of the flank attack category, the ball possession may be set opposite, that is, from Home to Away and from Away to Home, such that the left and right of the ball coordinate rule are reversed, to generate a rule of a side defense category.

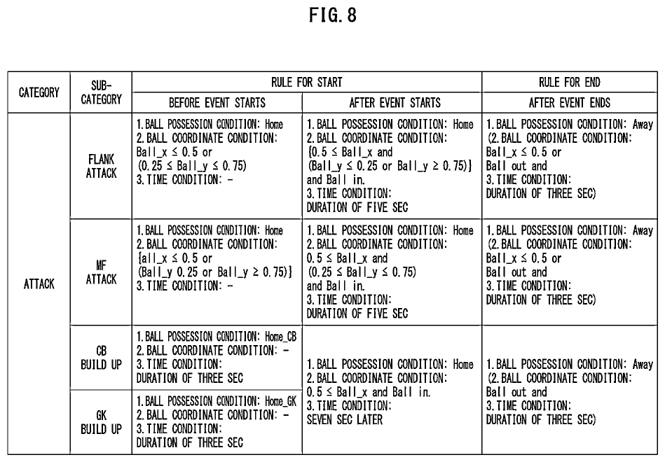

FIGS. 8 to 11 illustrate default rule parameters and start rules and end rules for each category of an event extraction module of the apparatus for extracting a rules-based event from a sports match video according to an embodiment of the present invention.

That is, referring to FIGS. 8 to 11, setting of default rule parameters and start rules and end rules for each of five categories and thirteen sub-categories of the event extraction module applicable to the apparatus for extracting a rules-based event from a sports match video according to an embodiment of the present invention is illustrated.

The five categories include an attack, a defense, a defense switch, an attack switch, and a set piece, and the thirteen categories include a flank attack, a midfielder (MF) attack, a center back (CB) build-up, a goalkeeper (GK) build-up, a P1 defense, a P2 defense, a P3 defense, a P2 defense switch, a P3 defense switch, a P1 attack switch, a P2 attack switch, a corner kick, and a throw-in.

Referring to FIG. 8, the conditions of an attack category of the event extraction module applicable to the apparatus for extracting a rules-based event from a sports match video according to an embodiment of the present invention are illustrated.

The conditions for extracting a flank attack event of the attack category are conditions that: in the rule for before the start of the event, the ball possession condition is set to Home, the ball coordinate condition is set to Ball_x≤0.5 or (0.25≤Ball_y≤0.75), and the time condition is set to null; in the rule for after the start of the event, the ball possession condition is set to Home, the ball coordinate condition is set to 0.5≤Ball_x and (Ball_y≤0.25 or 0.75≤Ball_y) and Ball-in, and the time condition is set to a duration of 5 seconds; and in the rule for after the end of the event, the ball possession condition is set to Away, the ball coordinate condition is set to Ball_x≤0.5 or Ball-out, and the time condition is set to a duration of three seconds.

In addition, the conditions for extracting an MF attack event of the attack category are conditions that: in the rule for before the start of the event, the ball possession condition is set to Home, the ball coordinate condition is set to Ball_x≤0.5 or (Ball_y≤0.25 or 0.75≤Ball_y), and the time condition is set to null; in the rule for after the start of the event, the ball possession condition is set to Home, the ball coordinate condition is set to 0.5≤Ball_x and (0.25≤Ball_y≤0.75) and Ball-in, and the time condition is set to a duration of five seconds; and in the rule for after the end of the event, the ball possession condition is set to Away, the ball coordinate condition is set to Ball_x≤0.5 or Ball-out, and the time condition is set to a duration of three seconds.

The conditions for extracting a CB buildup event of the attack category are conditions that: in the rule for before the start of the event, the ball possession condition is set to Home CB, the ball coordinate condition is set to null, and the time condition is set to a duration of three seconds; in the rule for after the start of the event, the ball possession condition is set to Home, the ball coordinate condition is set to 0.5≤Ball_x and Ball-in, and the time condition is set to seven seconds later; and in the rule for after the end of the event, the ball possession condition is set to Away, and the ball coordinate condition is set to Ball-out, and the time condition is set to a duration of three seconds.

The conditions for extracting a GK buildup event of the attack category are conditions that: in the rule for before the start of the event, the ball possession condition is set to Home GK, the ball coordinate condition is set to null, and the time condition is set to a duration of three seconds; in the rule for after the start of the event, the ball possession condition is set Home, the ball coordinate condition is set to 0.5≤Ball_x and Ball-in), and the time condition is set to seven seconds later; and in the rule for after the end of the event, the ball possession condition is set to Away, the ball coordinate condition is set to Ball-out, and the time condition is set to a duration of three seconds.

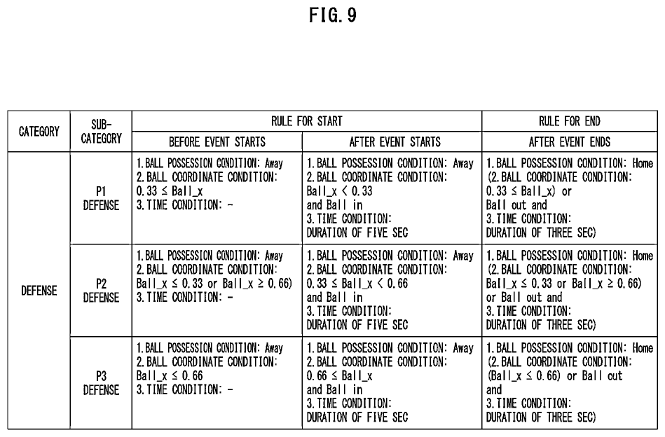

Referring to FIG. 9, the conditions of a defense category of the event extraction module applicable to the apparatus for extracting a rules-based event from a sports match video according to an embodiment of the present invention are illustrated.

The cases of extracting a P1 defense event of the defense category are cases where: in the rule for before the start of the event, the ball possession condition is set to Away, the ball coordinate condition is set to 0.33≤Ball_x, and the time condition is set to null; in the rule for after the start of the event, the ball possession condition is set to Away, the ball coordinate condition is set to Ball_x≤0.33 and Ball-in, the time condition is set to a duration of five seconds; and in the rule for after the end of the event, the ball possession condition is set to Home, the ball coordinate condition is set to (0.33≤Ball_x) or Ball-out, and the time condition is set to a duration of three seconds.

The conditions for extracting a P2 defense event of the defense category are conditions that: in the rule for before the start of the event, the ball possession condition is set to Away, the ball coordinate condition is set to Ball_x≤0.33 or Ball_x≥0.66, and the time condition is set to null; in the rule for after the start of the event, the ball possession condition is set to Away, the ball coordinate condition is set to (0.33≤Ball_x≤0.66) and Ball-in, and the time condition is set to a duration of five seconds; and in the rule for after the end of the event, the ball possession condition is set to Home, the ball coordinate condition is set to (Ball_x≤0.33 or Ball_x≥0.66) or Ball-out, and the time condition is set to a duration of three seconds.

The conditions for extracting a P3 defense event of the defense category are conditions that: in the rule for before the start of the event, the ball possession condition is set to Away, the ball coordinate condition is set to Ball_x≤0.66, and the time condition is set to null; in the rule for after the start of the event, the ball possession condition is set to Away, the ball coordinate condition is set to 0.66≤Ball_x and Ball in, and the time condition is set to a duration of five seconds; and in the rule for after the end of the event, the ball possession condition is set to Home, the ball coordinate condition is set to (Ball_x≤0.66) or Ball-out, and the time condition is set to a duration of three seconds.

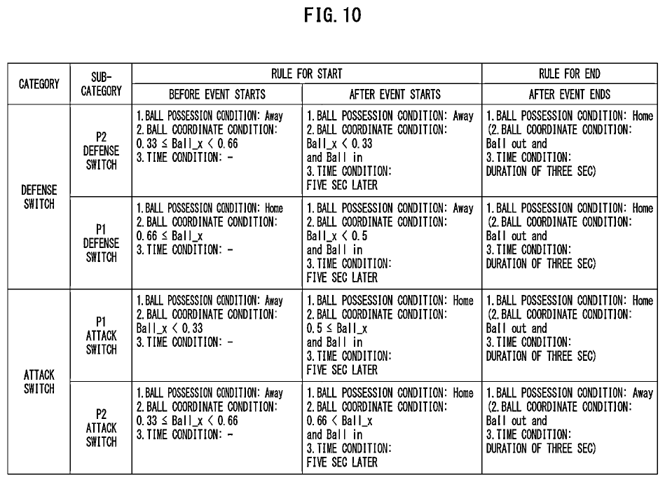

Referring to FIG. 10, the conditions of a defense switch category and an attack switch category of the event extraction module applicable to the apparatus for extracting a rules-based event from a sports match video according to an embodiment of the present invention are illustrated.

The conditions for extracting a P2 defense switch event of the defense switch category are conditions that: in the rule for before the start of the event, the ball possession condition is set to Home, the ball coordinate condition is set to 0.33≤Ball_x≤0.66, and the time condition is set to null; in the rule for after the start of the event, the ball possession condition is set to Away, the ball coordinate condition is set to Ball_x<0.33 and Ball-in, and the time condition is set to five seconds later; and in the rule for after the end of the event, the ball possession condition is set to Home, the ball coordinate condition is set to ball-out (Ball-out), and the time condition is set to a duration of three seconds.

The conditions for extracting a P3 defense switch event of the defense switch category are conditions that: in the rule for before the start of the event, the ball possession condition is set to Home, the ball coordinate condition is set to 0.66≤Ball_x, and the time condition is set to null; in the rule for after the start of the event, the ball possession condition is set to Away, the ball coordinate condition is set to Ball_x<0.5 and Ball-in, and the time condition is set to 5 seconds later; and in the rule for after the end of the event, the ball possession condition is set to Home, the ball coordinate condition is set to Ball-out, and the time condition is set to a duration of three seconds.

The conditions for extracting a P1 attack switch event of the attack switch category are conditions that: in the rule for before the start of the event, the ball possession condition is set to Away, the ball coordinate condition is set to Ball_x<0.33, and the time condition is set to null; in the rule for after the start of the event, the ball possession condition is set to Home, the ball coordinate condition is set to 0.5<Ball_x and Ball-in, and the time condition is set to five seconds later; and in the rule for after the end of the event, the ball possession condition is set to Away, the ball coordinate condition is set to Ball-out, and the time condition is set to a duration of three seconds.

The conditions for extracting a P2 attack switch event of the attack switch category are conditions that: in the rule for before the start of the event, the ball possession condition is set to Away, the ball coordinate condition is set to 0.33≤Ball_x<0.66, and the time condition is set to null; in the rule for after the start of the event, the ball possession condition is set to Home, the ball coordinate condition is set to 0.66<Ball_x and Ball-in, and the time condition is set to five seconds later; and in the rule for after the end of the event, the ball possession condition is set to Away, the ball coordinate condition is set to ball-out, and the time condition is set to a duration of three seconds.

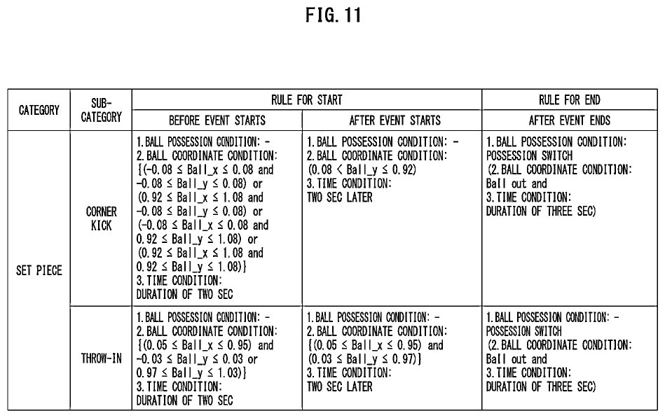

Referring to FIG. 11, the conditions of a set piece category of the event extraction module applicable to the apparatus for extracting a rules-based event from a sports match video according to an embodiment of the present invention are illustrated.

The conditions for extracting a corner kick event of the set piece category are conditions that: in the rule for before the start of the event, the ball possession condition is set to null, the ball coordinate condition is set to {(−0.08≤Ball_x≤0.08 and −0.08≤Ball_y≤0.08) or (0.92≤Ball_x≤1.08 and −0.08≤Ball_y≤0.08) or (−0.08≤Ball_x≤0.08 and 0.92≤Ball_y≤1.08) or (0.92≤Ball_x≤1.08 and 0.92≤Ball_y≤1.08)}, and the time condition is set to a duration of two seconds; in the rule for after the start of the event, the ball possession condition is set to null, the ball coordinate condition is set to 0.08≤Ball_y≤0.92, and the time condition is set to two seconds later; and in the rule for after the end of the event, the ball possession condition is set to the possession switch, the ball coordinate condition is set to Ball-out, and the time condition is set to a duration of three seconds.

The conditions for extracting a throw-in event of the set piece category are conditions that: in the rule for before the start of the event, the ball possession condition is set to null, the ball coordinate condition is set to {(0.05≤Ball_x≤0.95), and (−0.03≤Ball_y≤0.03 or 0.97≤Ball_y≤1.03)}, and the time condition is set to a duration of two seconds; in the rule for after the start of the event, the ball possession condition is set to null, the ball coordinate condition is set to {(0.05≤Ball_x≤0.95) and (0.03≤Ball_y≤0.97)}, and the time condition is set to two seconds later; and in the rule for after the end of the event, the ball possession condition is set to possession switch, the ball coordinate condition is set to ball-out, and the time condition is set to a duration of three seconds.

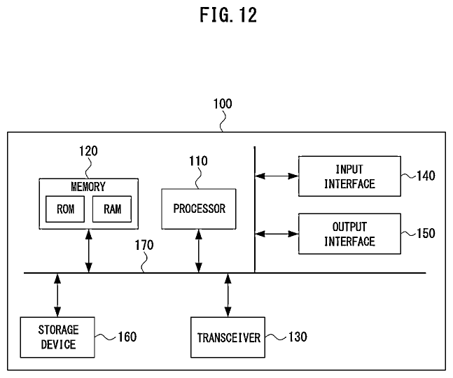

FIG. 12 is a block diagram of an apparatus for extracting a rules-based event from a sports match video according to an embodiment of the present invention.

Referring to FIG. 12, the apparatus 100 for extracting a rules-based event from a sports match video includes a processor 110, a memory 120, a transceiver 130, an input interface 140, an output interface 150, a storage device 160, and a bus 170.

The apparatus 100 for extracting a rules-based event from a sports match video may include a processor and a memory in which at least one command executed through the processor is stored, wherein the at least one command may be configured to allow the processor to: extract ball possession from player and ball tracking coordinate data extracted from a sports match video; after completion of extraction of the ball possession, set a category-specific rule of an event desired to be extracted; activate the event when a rule for before the start of the event and a rule for after the start of the event are satisfied as the sports match progresses; and deactivate the event when the rule for the end of the event is satisfied.

The processor 110 may be a central processing unit (CPU), a graphics processing unit (GPU), or a dedicated processor for performing the methods according to the embodiments of the present invention.

Each of the memory 120 and the storage device 160 may include at least one of a volatile storage medium and a non-volatile storage medium. For example, the memory 120 may include at least one of a read only memory (ROM) and a random-access memory (RAM).

The components included in the apparatus 100 for extracting a rules-based event from a sports match video may be connected by the bus 170 to communicate with each other.

The apparatus 100 for extracting a rules-based event from a sports match video may be implemented as a communicable desktop computer, a laptop computer, a notebook personal computer (PC), a smart phone, a tablet PC, a mobile phone, a smart watch, smart glasses, an e-book reader, a portable multimedia player (PMP), a portable game console, a navigation device, a digital camera, a digital multimedia broadcasting (DMB) player, a digital audio recorder, a digital audio player, a digital video recorder, a digital video player, a personal digital assistant (PDA), and the like.

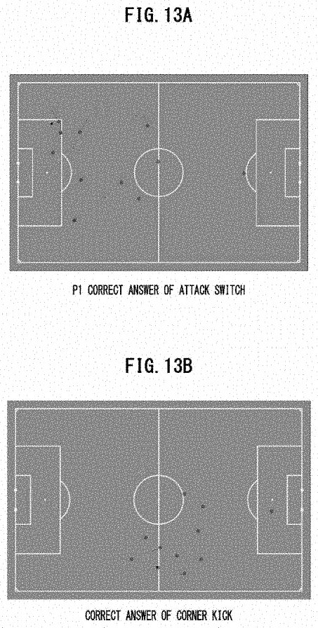

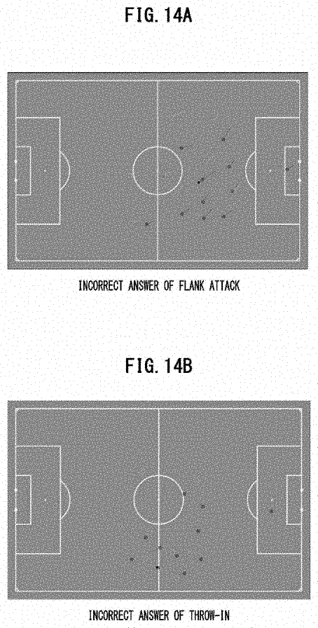

FIGS. 13A and 13B are schematic diagrams for describing an example of a rule-applied correct answer of the apparatus for extracting a rules-based event from a sports match video according to the embodiment of the present invention, and FIGS. 14A and 14B are schematic diagrams for describing an example of a rule-applied incorrect answer of the apparatus for extracting a rules-based event from a sports match video according to the embodiment of the present invention.

As illustrated in FIGS. 13A and 13B and FIGS. 14A and 14B, the following experiment was conducted to investigate the performance of the apparatus for extracting a rules-based event from a sports match video according to the embodiment of the present invention.

Usage data is a sports match video posted on Metrica Sports Sample data, including image tracking coordinate data disclosed by Metrica Sports, a soccer match video analysis company, in which player and team data is anonymized. Here, the coordinates were extracted at a rate of 25 fps, and the x and y coordinates were scaled to values between 0 and 1.

In order to measure the performance of the event extraction, since there is no correct answer event data for each category, the precision of Equation 1 was calculated to measure the performance of the event extraction.

$$Precision = \frac{\begin{matrix}The number of extracted events \\ that correspond to a category in practice\end{matrix}}{the number of extracted events} \qquad [ Equation 1 ]$$

The performance of the apparatus for extracting a rules-based event from a sports match video according to the embodiment has the precision shown in Table 3.

TABLE 3

| Category | Precision |
|---|---|
| Corner kick | 1.0 |
| Throw-in | 0.69 |
| MF attack | 0.85 |
| Flank attack | 0.97 |
| CB build up | 0.91 |
| GK build up | 1.0 |
| P1 defense | 1.0 |
| P2 defense | 1.0 |
| P3 defense | 0.91 |
| P1 attack switch | 1.0 |
| P2 attack switch | 1.0 |
| P2 defense switch | 1.0 |
| P3 defense switch | 1.0 |

The precision of the event extracted by the apparatus for extracting a rules-based event from a sports match video according to the embodiment, when compared with the precision of the event of the actual sports match evaluated by a professional analyst with respect to the sports videos shown in FIGS. 13A and 13B, showed a judgment result of matching every time as a value of 1, for the events of the corner kick, the GK build-up, the P1 defense, the P2 defense, the P1 attack switch, the P2 attack switch, the P2 defense switch, and the P3 defense switch.

However, for the events extracted from the sports vieso shown in FIGS. 14A and 14B, that is, the flank attack (0.97), the CB build-up (0.91), and the P3 defense (0.91), the apparatus correctly judged nine out of ten times and showed a different judgment the remaining one out of the ten times, and for the throw-in (0.69), showed different judgments three out of ten times.

As described above, according to the present invention, an apparatus for extracting a rules-based event from a sports match video with excellent performance can be provided, thereby automating event extraction in sports events, such as soccer, which has been manually performed by performance analyzers in the past, so that the time and effort required for tactic analysis can be remarkably reduced. In addition, new functions can be added and applied to a sports match video analysis system. In addition, as the user sets the rules, the category of an event to be extracted can be freely expanded. In addition, the use can be extended to a sports match video analysis system of various ball sports, such as basketball and volleyball, in addition to soccer.

As is apparent from the above, according to the present invention, the apparatus for extracting a rules-based event from a sports match video can automate event extraction, which has been manually performed by performance analyzers in the past, thereby remarkably reducing the time and effort required for tactic analysis.

According to the present invention, the method and apparatus for extracting a rules-based event from a sports match video can add and apply a new function to a sports match video analysis system.

According to the present invention, the method and apparatus for extracting a rules-based event from a sports match video can allow a user to set rules so that a category of events to be extracted can be freely expanded.

In addition, according to the present invention, the method and apparatus for extracting a rules-based event from a sports match video can be extensively applied to a sports match video analysis system of various ball sports, such as basketball and volleyball, in addition to soccer.

While example embodiments of the present invention and their advantages have been described in detail, it should be understood that various changes, substitutions and alterations may be made herein without departing from the scope of the invention.

What is claimed is:

1. A method of extracting a ruled-based event form a sports match video, the method comprising:
setting rules for each category of events to be extracted from a sports match video;
extracting ball possession and ball coordinates based on tracking coordinate data of at least one player and tracking coordinate data of a ball in the sports match video;
identifying that an event of a specific category is started at a specific point in time of the sports match video when a condition for before a start of an event and a condition for after a start of an event in the rule are satisfied; and
identifying that the event is ended at another specific point in time of the sports match video when a condition for an end of an event in the rule is satisfied.

2. The method of claim 1, wherein the categories include an attack category, a defense category, an attack switch category, a defense switch category, and a set piece category, and each of the categories includes a plurality of preset sub-categories.

3. The method of claim 2, wherein the rules include a rule for before the start of an event, a rule for after the start of an event, and a rule for the end of an event, and
each of the rule for before the start of the event, the rule for after the start of the event, and the rule for the end of the event includes a condition for ball possession, a condition for ball coordinates, and a time condition.

4. The method of claim 3, wherein the tracking coordinate data and the ball coordinates are extracted based on a coordinate system in which coordinates of one corner of a soccer field in the sports match video are set to (0.0), and coordinates of another corner located diagonally opposite to the one corner are set to (1.1).

5. The method of claim 4, wherein ball-out and ball-in, which are default rules among the rules, have parameters in which the parameters for the ball-out are defined as (0.0>Ball_x), (1.0<Ball_x), (0.0>Ball_y) or (1.0<Ball_y) and the parameters for the ball-in are defined as (0.0<Ball_x<1.0) and (0.0<Ball_y<1.0),
wherein the Ball_x and the Ball_y represent an x coordinate and a y-coordinate of the ball, respectively.

6. The method of claim 3, further comprising:
tagging the ball possession with “Home” when a player closest to the ball belongs to a home team, and tagging the ball possession with “Away” when a player closest to the ball belongs to an away team; and
while checking a player who is the closest to the ball at certain time intervals, when a team not having had the ball possession remains the closest to the ball for a predetermined time limit, switching the ball possession to the opposing team.

7. The method of claim 6, further comprising setting a predetermined time limit to prevent a situation in which, when one player of the team having the ball possession passes the ball to another player of the same team, the movement of the ball causes the ball possession to be tagged with the opposing team.

8. The method of claim 3, wherein the sub-categories of the attack category among the categories include a flank attack, a midfielder (MF) attack, a center back (CB) build-up, and a goalkeeper (GK) build-up,
the sub-categories of the defense category among the categories include a P1 defense, a P2 defense, and a P3 defense,
the sub-categories of the defense switch category among the categories include a P2 defense switch and a P3 defense switch,
the sub-categories of the attack switch category among the categories include a P1 attack switch and a P attack switch, and
the sub-categories of the set piece category among the categories include a corner kick and a throw-in.

9. The method of claim 8, wherein the event includes a flank attack event, an MF attack event, a CB build-up event, a GK build-up event, a P1 defense event, a P2 defense event, a P3 defense event, a P2 defense switch event, a P3 defense switch event, a P1 attack switch event, a P2 attack switch event, a corner kick event, and a throw-in event.

10. The method of claim 9, wherein the start and the end of the event are determined according to a condition that is set in advance for each event corresponding to a specific item of the sub-category.

11. An apparatus for extracting a rules-based event from a sports match video, the apparatus comprising:
a processor; and
a memory in which at least one command to be executed by the processor is stored,
wherein the at least one command is configured to allow the processor to perform operations of:
setting rules for each category of events to be extracted from a sports match video;
extracting ball possession and ball coordinates based on tracking coordinate data of at least one player and tracking coordinate data of a ball in the sports match video;
identifying that an event of a specific category is started at a specific point in time of the sports match video when a condition for before a start of an event and a condition for after a start of an event in the rule are satisfied; and
identifying that the event is ended at another specific point in time of the sports match video when a condition for an end of an event in the rule is satisfied.

12. An apparatus for extracting a rules-based event from a sports match video, the apparatus comprising:
a ball possession extraction unit configured to extract ball possession from tracking coordinate data of a player and a ball extracted from a sports match video, and a list of the extracted ball possession in a ball possession list storage unit;
a category-specific rule setting unit configured to set a rule for before a start of an event, a rule for after a start of an event, and a rule for an end of an event as category-specific rules on the basis of a ball possession condition, a ball coordinate condition, and a time condition that are extracted according to a user input parameter stored in a user input parameter storage unit, and store the set category-specific rules in a category-specific rule storage unit;
a rule-based event extraction unit configured to, when an event of a specific category starts at a specific point in time of the sports match video in response to the rule for before the start of the event and the rule for after the start of the event being satisfied and the event ends at another specific point in time of the sports match video in response to the rule for the end of the event being satisfied, store a rule-based event that is completed with an event start and an event end as a candidate event for each category in a category-specific candidate event storage unit;
a category-specific event adjusting unit configured to, while checking the extracted candidate event for each category, add or remove an event to generate an event list for each category, and store the generated event list for each category in a category-specific event list storage unit; and
a category-specific event reproduction unit configured to, after event extraction is complete, reproduce an event with the sports match video stored in a sports match video storage unit and a 2D or Voronoi animation stored in an animation storage unit.

13. The apparatus of claim 12, further comprising a tracking coordinate data extraction unit configured to extract tracking coordinate data including coordinates of a player, coordinates of a ball, and time data on the basis of coordinate data of the player and the ball from the sports match video in a coordinate data storage unit.

14. The apparatus of claim 13, wherein the tracking coordinate data, the coordinates of the player, and the coordinates of the ball are extracted based on a coordinate system in which coordinates of one corner of a soccer field in the sports match video are set to (0.0), and coordinates of another corner located diagonally opposite to the one corner are set to (1.1).

15. The apparatus of claim 14, wherein ball-out and ball-in, which are default rules, have parameters in which the parameters for the ball-out are defined as (0.0>Ball_x), (1.0<Ball_x), (0.0>Ball_y) or (1.0<Ball_y) and the parameters for the ball-in are defined as (0.0<Ball_x<1.0) and (0.0<Ball_y<1.0),
wherein the Ball_x and the Ball_y represent an x coordinate and a y coordinate of the ball, respectively.

16. The apparatus of claim 12, wherein the category-specific event adjusting unit is configured to tag the ball possession with “Home” when a player closest to the ball belongs to a home team, and tag the ball possession with “Away” when a player closest to the ball belongs to an away team; and while checking a player who is the closest to the ball at certain time intervals, when a team not having had the ball possession remains the closest to the ball for a predetermined time limit, switch the ball possession to the opposing team.

17. The apparatus of claim 16, wherein the category-specific event adjusting unit is configured to set a predetermined time limit to prevent a situation in which, when one player of the team having the ball possession passes the ball to another player of the same team, movement of the ball causes the ball possession to be tagged with the opposing team.

18. The apparatus of claim 12, wherein the categories include an attack category, a defense category, an attack switch category, a defense switch category, and a set piece category,
the sub-categories of the attack category include a flank attack, a midfielder (MF) attack, a center back (CB) build-up, and a goalkeeper (GK) build-up,
the sub-categories of the defense category include a P1 defense, a P2 defense, and a P3 defense,
the sub-categories of the defense switch category include a P2 defense switch and a P3 defense switch,
the sub-categories of the attack switch category include a P1 attack switch and a P attack switch, and
the sub-categories of the set piece category include a corner kick and a throw-in.

19. The apparatus of claim 18, wherein the event includes a flank attack event, an MF attack event, a CB build-up event, a GK build-up event, a P1 defense event, a P2 defense event, a P3 defense event, a P2 defense switch event, a P3 defense switch event, a P1 attack switch event, a P2 attack switch event, a corner kick event, and a throw-in event.

20. The apparatus of claim 19, wherein the start and the end of the event are determined according to a condition that is set in advance for each event corresponding to a specific item of the sub-category.
